(19) United States
(12) Patent Application Publication
(10) Pub. No.: US 2008/0107175 A1
(43) Pub. Date: May 8, 2008

(54) METHOD AND APPARATUS FOR ENCODING AND DECODING BASED ON INTRA PREDICTION

(75) Inventors: Woo-jin HAN, Suwon-si (KR); Bae-keun LEE, Bucheon-si (KR); Tammy LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/936,454

(22) Filed: Nov. 7, 2007

Related U.S. Application Data
(60) Provisional application No. 60/857,120, filed on Nov. 7, 2006.

(30) Foreign Application Priority Data
Jan. 18, 2007 (KR) 10-2007-0005808

(51) Int. Cl. H04N 7/26

(52) U.S. Cl. 375/240.12; 375/E07.127

(57) ABSTRACT

Provided are a method and apparatus for encoding and decoding based on intra prediction. The method of encoding based on intra prediction includes predicting a current block by searching for a pre-encoded area in a current picture using pre-encoded pixels adjacent to the current block, and intra prediction encoding the current block so that information indicating that the current block is intra predicted via the predicting of the current block is included. Accordingly, the compression rate of intra prediction encoding is increased even when the current block is not appropriately predicted by using a prediction value obtained from pixels adjacent to the current block.

### CROSS-REFERENCE TO RELATED PATENT APPLICATION

This application claims the benefit of Korean Patent Application No. 10-2007-0005808, filed on Jan. 18, 2007 in the Korean Intellectual Property Office, and U.S. Provisional Application No. 60/857,120, filed on Nov. 7, 2006 in the U.S. Patent and Trademark Office, the disclosures of which are incorporated herein in their entirety by reference.

### BACKGROUND OF THE INVENTION

1. Field of the Invention

Methods and apparatuses consistent with the present invention relate to encoding and decoding based on intra prediction, and more particularly, to performing intra prediction encoding by predicting a current block that is to be intra prediction encoded from a block in a pre-encoded area in a current picture.

2. Description of the Related Art

In related art methods of compressing an image, such as MPEG-1, MPEG-2, and MPEG-4H.264/MPEG-4 advanced video coding (AVC), a picture is divided into macroblocks in order to encode an image. Then, each macroblock is encoded using inter prediction and intra prediction. Next, the macroblocks are encoded after selecting a suitable encoding mode by considering data size of the encoded macroblock and distortion of the original macroblock.

In intra prediction, a macroblock of a current picture is encoded using pixel values spatially adjacent to the current block that is to be encoded, instead of being encoded using a reference picture. First, a prediction value of the current block that is to be encoded is calculated using adjacent pixel values. Then, a difference between the prediction value and a pixel value of the original current block is encoded. Here, intra prediction modes can be largely divided into an intra prediction mode in luminance components and an intra prediction mode in chrominance components. The intra prediction mode in luminance components is divided into 4×4 intra prediction mode, 8×8 intra prediction mode, and 16×16 intra prediction mode.

FIG. 1 illustrates a related art 16×16 intra prediction mode.

Referring to FIG. 1, the 16×16 intra prediction mode includes a total of four modes, i.e. a vertical mode, a horizontal mode, a direct current (DC) mode, and a plane mode.

FIG. 2 illustrates a related art 4×4 intra prediction mode.

Referring to FIG. 2, the 4×4 intra prediction mode includes a total of nine modes, i.e. a vertical mode, a horizontal mode, a DC mode, a diagonal down-left mode, a diagonal down-right mode, a vertical right mode, a vertical left mode, a horizontal-up mode, and a horizontal-down mode.

Prediction mode numbers indexed in each mode are determined based on the frequency of using each mode. The vertical mode, i.e., mode 0, is the most frequently used mode while performing an intra prediction on a corresponding block, and the horizontal-up mode, i.e., mode 8, is the least used.

For example, operations of prediction encoding a 4×4 current block using mode 0 of FIG. 2, i.e. the vertical mode, will be described. First, pixel values of pixels A through D, adjacent to an upper part of the 4×4 current block, are predicted as pixel values of the 4×4 current block. That is, the pixel value of pixel A is predicted as four pixel values included in the first column of the 4×4 current block, the pixel value of pixel B is predicted as four pixel values included in the second column of the 4×4 current block, the pixel value of pixel C is predicted as four pixel values included in the third column of the 4×4 current block, and the pixel value of pixel D is predicted as four pixel values included in the fourth column of the 4×4 current block. Next, the difference between the prediction values of the 4×4 current block predicted using pixels A through D and actual values of pixels included in the original 4×4 current block is obtained, and a bit-stream of the 4×4 current block is generated by encoding the difference.

In encoding an image according to the H.264 standard, a current block is encoded using a total of 13 modes from the 4×4 intra prediction mode and the 16×16 intra prediction and then a bit stream of the current block is generated according to the optimum mode from among the 13 modes.

According to a related art intra prediction method as illustrated in FIGS. 1 and 2, the current block is predicted using pixels adjacent to a current block, that is, pixels included in at least one of left, upper, and upper left blocks.

However, when pixels included in the current block do not have pixel values in a uniform rule as illustrated in FIGS. 1 and 2, residue of the current block increases by performing intra prediction according to examples illustrated in FIGS. 1 and 2, and thus the efficiency of compressing an image decreases. Specifically when the current block is repeated in the current picture, and residue with a prediction value predicted by adjacent pixels is big but residue obtained using repetition property in the current picture is small, the efficiency of compressing an image can be increased using such a repetition property.

FIG. 3 illustrates a related art intra prediction method. The illustrated method for predicting motion in a current picture 300 increases efficiency of compressing an image using repetition in a picture.

Referring to FIG. 3, in encoding the current picture 300, an encoding apparatus searches for a block 331 similar to a current block 330 in the current picture 300 from a pre-encoded area 310 of the current picture 300, and obtains and encodes a vector 332 of the block 331 based on a result of the search. During a decoding process, a prediction value of the current block 330 is obtained from other blocks in the current picture 300 using the vector 332, and the prediction value is added to residue in order to restore the original current block. However in this case, information about the vector 332 needs to be transmitted in order to decode an image, and thus the efficiency of compressing is not large enough.

### SUMMARY OF THE INVENTION

The present invention provides a method and apparatus for encoding and decoding based on intra prediction, which can encode a current block by searching a pre-encoded area in a current picture, and a computer readable recording medium having recorded thereon a program for executing the method.

According to an aspect of the present invention, there is provided a method of encoding based on intra prediction, the method including: searching for a pre-encoded area in a current picture using pre-encoded pixels adjacent to a current block and intra predicting the current block based on the result of the search; and intra prediction encoding the current block based on the intra predicting of the current block.

The intra predicting of the current block may include: selecting N blocks adjacent to pixels having low residue with the pre-encoded pixels adjacent to the current block by searching for the pre-encoded area in the current picture using the pre-encoded pixels adjacent to the current block; and intra predicting the current block based on at least one of the selected N blocks.

The intra predicting of the current block may include intra predicting the current block by searching only for M macroblocks having low compression rate of encoding from within the pre-encoded area in the current picture.

According to another aspect of the present invention, there is provided an apparatus for encoding based on an intra prediction, the apparatus including: an intra predictor which searches for a pre-encoded area in a current picture using pre-encoded pixels adjacent to a current block and intra predicts the current block based on the result of the search; and an encoder which performs intra prediction encoding on the current block based on the intra prediction of the current block.

The intra predictor may include: a selector which selects N blocks adjacent to pixels having low residue with the pre-encoded pixels adjacent to the current block by searching for the pre-encoded area in the current picture using the pre-encoded pixels adjacent to the current block; and a prediction performer which intra predicts the current block based on at least one of the selected N blocks.

The intra predictor may intra predict the current block by searching only for M macroblocks having a low compression rate of encoding from within the pre-encoded area in the current picture.

According to another aspect of the present invention, there is provided a method of decoding based on intra prediction, the method including: receiving a bit stream comprising information about an intra prediction mode of the current block indicating that the current block is predicted by searching for a pre-encoded area in a current picture using pre-encoded pixels adjacent to a current block, and extracting the information from the received bit stream; and intra predicting the current block based on the information about the intra prediction mode.

According to another aspect of the present invention, there is provided an apparatus for decoding based on an intra prediction, the apparatus including: an extractor which receives a bit stream including information about an intra prediction mode of the current block indicating that the current block is predicted by searching for a pre-encoded area in a current picture using pre-encoded pixels adjacent to a current block, and extracting the information from the received bit stream; and an intra predictor which intra predicts the current block based on the information about the intra prediction mode.

According to another aspect of the present invention, there is provided a computer readable recording medium having recorded thereon a program for executing the method of encoding and decoding an image based on intra prediction as described above.

### BRIEF DESCRIPTION OF THE DRAWINGS

The above and other aspects of the present invention will become more apparent by describing in detail exemplary embodiments thereof with reference to the attached drawings in which:

FIG. 1 illustrates a related art 16×16 intra prediction mode;

FIG. 2 illustrates a related art 4×4 intra prediction mode;

FIG. 3 illustrates a related art intra prediction method;

FIG. 4 illustrates an image encoding apparatus including an apparatus for encoding based on intra prediction according to an exemplary embodiment of the present invention;

FIG. 5 illustrates an intra predictor of an apparatus for encoding based on intra prediction according to an exemplary embodiment of the present invention;

FIG. 6 illustrates an intra prediction method according to an exemplary embodiment of the present invention;

FIG. 7 illustrates an intra prediction method according to another exemplary embodiment of the present invention;

FIG. 8 illustrates an intra prediction method according to another exemplary embodiment of the present invention;

FIG. 9 illustrates a method of encoding information about an intra prediction method according to an exemplary embodiment of the present invention;

FIG. 10 illustrates a method of encoding based on intra prediction according to an exemplary embodiment of the present invention;

FIG. 11 illustrates an image decoding apparatus including an apparatus for decoding based on intra prediction according to an exemplary embodiment of the present invention;

FIG. 12 illustrates an intra predictor of an apparatus for decoding based on intra prediction according to an exemplary embodiment of the present invention; and

FIG. 13 illustrates a method of decoding based on intra prediction according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

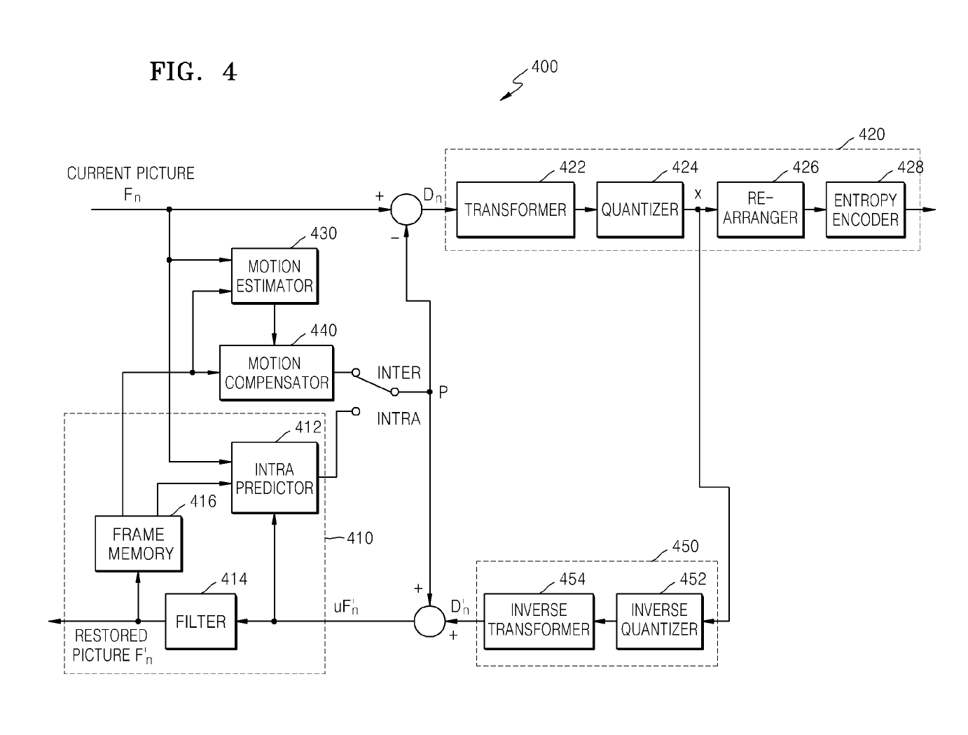

FIG. 4 illustrates an image encoding apparatus 400 including an apparatus for encoding based on intra prediction according to an exemplary embodiment of the present invention. Hereinafter, an image encoding apparatus according to the H.264 standard will be described for convenience. However, one of ordinary skill in the art can easily understand that the apparatus for encoding based on intra prediction according to the current exemplary embodiment can be applied to an image encoding apparatus using other intra prediction modes.

Referring to FIG. 4, the image encoding apparatus 400 includes an intra prediction performer 410, an encoder 420, a motion estimator 430, a motion compensator 440, and a restorer 450. Here, the intra prediction performer 410 and the encoder 420 correspond to the apparatus for encoding based on intra prediction according to the current exemplary embodiment.

The motion estimator 430 and the motion compensator 440 perform inter prediction, in which a prediction value of a macroblock of a current picture is searched for from a reference picture.

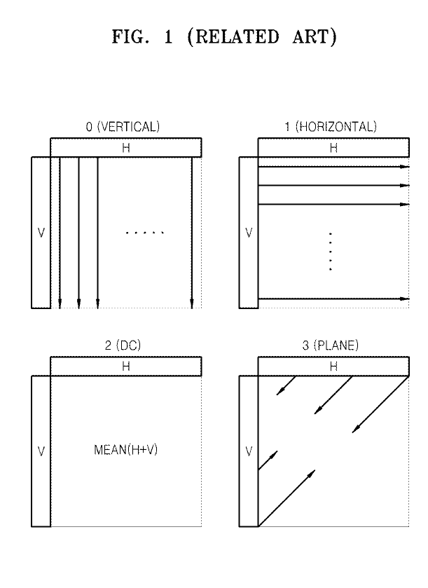

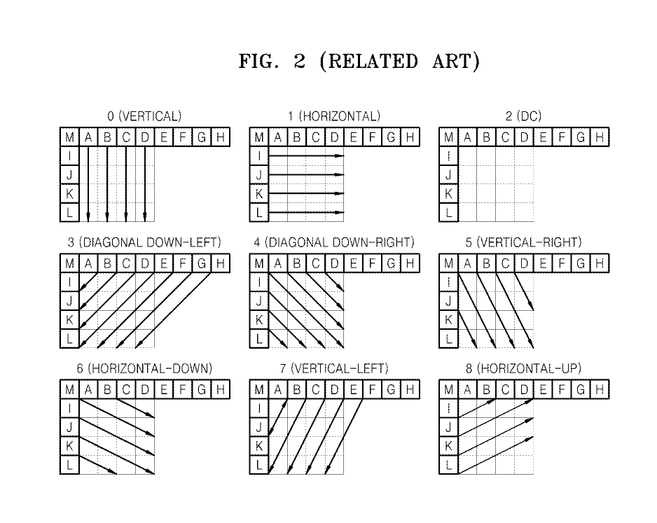

The intra prediction performer 410 performs an intra prediction in which a prediction value of a current block is searched for from a current picture. Specifically, the intra prediction performer 410 can perform a related art intra prediction using the 16×16 intra prediction mode, the 4×4 intra prediction mode, the 8×8 intra prediction mode, or the chrominance intra prediction mode as illustrated in FIGS. 1 and 2 described above, by receiving a current block that is to be intra prediction encoded. Also, the intra prediction performer 410 searches for a pre-encoded area in the current picture using pre-encoded pixels adjacent to a current block, and predicts the current block based on the result of the search.

An area pre-encoded by the encoder 420 from within an area included in the current picture is decoded by the decoder 450 and stored in a frame memory 416 in order to be used by an intra predictor 412. The intra predictor 412 according to an exemplary embodiment of the present invention searches for the pre-encoded area in the current picture stored in the frame memory 416 using pixels adjacent to the current block, and predicts the current block based on the result of the search. Details will be described later with reference to FIGS. 6, 7, and 8.

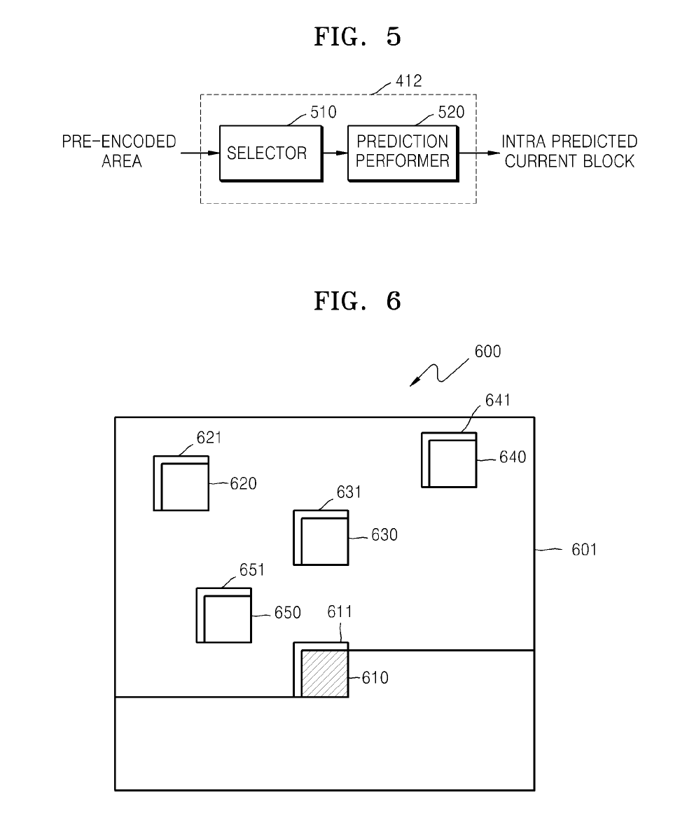

FIG. 5 illustrates an intra predictor 412 of an apparatus for encoding based on intra prediction according to an exemplary embodiment of the present invention.

Referring to FIG. 5, the intra predictor 412 according to the current exemplary embodiment includes a selector 510 and a prediction performer 520.

The selector 510 searches for a block that is to be used in predicting the current block by searching for the pre-encoded area in the current picture stored in the frame memory 416.

Preferably, the pre-encoded area in the current picture is searched using pre-encoded pixels adjacent to the current block. During the search, N blocks having the minimum residue with pixels adjacent to the current block are selected in order, and the N blocks adjacent to the searched pixels can be selected as the blocks used for predicting the current block.

FIG. 6 illustrates an intra prediction method according to an exemplary embodiment of the present invention.

Referring to FIG. 6, a prediction value of a current block 610 that is to be intra predicted is obtained by searching a pre-encoded area 601 in a current picture 600. A method of predicting the current block 610 by searching the pre-encoded area 601 has been suggested before, but according to a related art method, the search was performed using pixel values of the original current block 610.

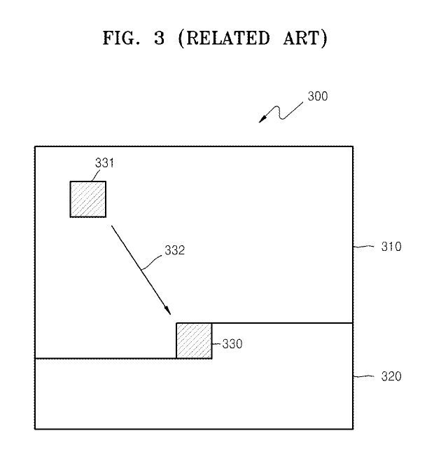

However, according to the current exemplary embodiment, a prediction block of the current block 610 is searched for using pre-encoded pixels 611 adjacent to the current block 610. The pixels 611 adjacent to the current block 610 are included in a pre-encoded area in the current picture 600. Since the search is performed using pixels included in the pre-encoded area, a current block can be predicted symmetrically using pre-decoded pixels while decoding intra prediction encoded blocks according to an exemplary embodiment of the present invention. Accordingly, information about the vector 332 illustrated in FIG. 3 for accurately specifying a block used in predicting the current block 610 is not required during a decoding process. Consequently, compression rate of intra prediction encoding is improved, since information about a vector is not encoded during an intra prediction encoding process.

Pixels having the minimum residue are found by searching the pre-encoded area 601 using the pixels 611 adjacent to the current block 610. Referring to FIG. 6, when pixels 621 on the upper left are searched, a block 620 adjacent to the pixels 621 is used as a prediction value of the current block 610.

Preferably, while searching the pre-encoded area 601 using the pixels 611 adjacent to the current block 610, a plurality of, i.e. N pixels having low residue can be searched for. N pixels 621, 631, 641, and 651 are searched for, which are the same or similar to the pixels 611 adjacent to the current block 610, by searching the pre-encoded area 601.

Since the search is performed using the pixels 611 adjacent to the current block 610, not the current block 610, a block 620 adjacent to the searched pixels does not always become a block having the minimum residue with the current block 610. Accordingly, N pixels 621, 631, 641, and 651 are searched for in an order of low residue using the pixels 611 adjacent to the current block 610, and the current block 610 is predicted using N blocks 620, 630, 640, and 650 adjacent to the searched for pixels.

The N blocks 620, 630, 640, and 650 are compared with the original current block 610 to select a block having the minimum residue, and the block having the minimum residue can be used as a prediction value of the current block 610. However, at least two blocks from among the N blocks 620, 630, 640, and 650 can be combined in order to be used in predicting the current block 610. For example, an average value of two blocks having low residue from among the searched for blocks, i.e. an average value of the block 620 and the block 630 can be used as the prediction value of the current block 610.

When the N blocks 620, 630, 640, and 650 are searched for and used in the intra prediction encoding, in order for a receiver, which receives an encoded bit stream, to decode the current block 610, the receiver should know which block from among the N blocks 620, 630, 640, and 650 is used in predicting the current block 610. Accordingly, the encoder 420 illustrated in FIG. 4 performs the intra prediction encoding so that information for specifying a block used in predicting the current block 610 is included when encoding residue of an intra predicted current block and the original current block 610. Details concerning the intra prediction encoding will be described later with reference to the encoder 420.

Referring back to FIG. 5, when the selector 510 searches for the pre-encoded area of the current picture using the pre-encoded pixels adjacent to the current block, it may be inefficient to search for the entire pre-encoded area of the current picture since workload of an encoding apparatus increases.

Accordingly, the selector 510 may select only a part of the pre-encoded area of the current picture using the pixels adjacent to the current block.

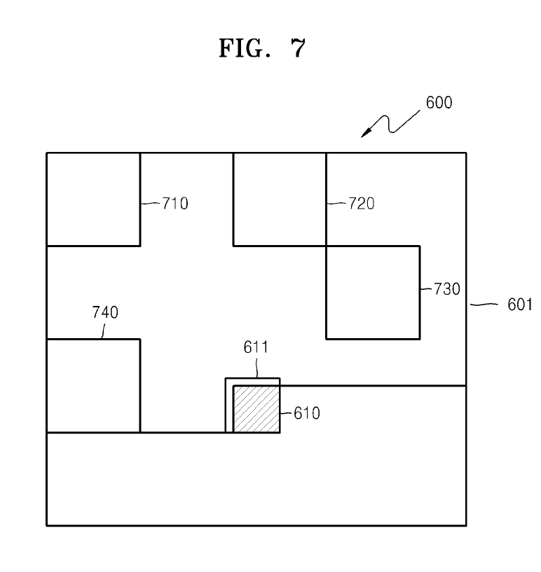

FIG. 7 illustrates an intra prediction method according to another exemplary embodiment of the present invention.

Referring to FIG. 7, the selector 510 illustrated in FIG. 5 searches for only M macroblocks 710, 720, 730, and 740 from within a pre-encoded area 601 in a current picture 600 using pixels 611 adjacent to a current block 610.

Only the M macroblocks 710, 720, 730, and 740 having a low compression rate of encoding are selected from within the pre-encoded areas of the current block 610 in order to perform the search. Macroblocks having a low compression rate of encoding are blocks that are not efficiently encoded using related art intra prediction methods. Accordingly, the current block is predicted by searching only for the macroblocks having low compression rate of encoding, and thus inefficiently repeating the encoding is prevented.

Other criteria besides the compression rate of encoding can be used in selecting the M macroblocks, and methods of efficiently performing intra prediction by limiting the search range of the selector 510 can be applied to the present invention.

Preferably, the intra prediction methods illustrated in FIGS. 6 and 7 can be combined and used. In other words, when the selector 510 searches the pre-encoded area of the current picture, only M macroblocks may be searched in order to select N blocks that are to be used in predicting the current block, and the current block may be predicted based on at least one of the selected N blocks.

Referring back to FIG. 4, the filter 414 performs de-blocking on the pre-encoded area of the current picture.

When the decoder 450 decodes the pre-encoded area of the current picture, each decoded block includes block artifacts while encoding and decoding are being performed in a block unit. Accordingly, in order for the intra predictor 412 to perform an accurate search, the decoded pre-encoded area needs to be de-blocked.

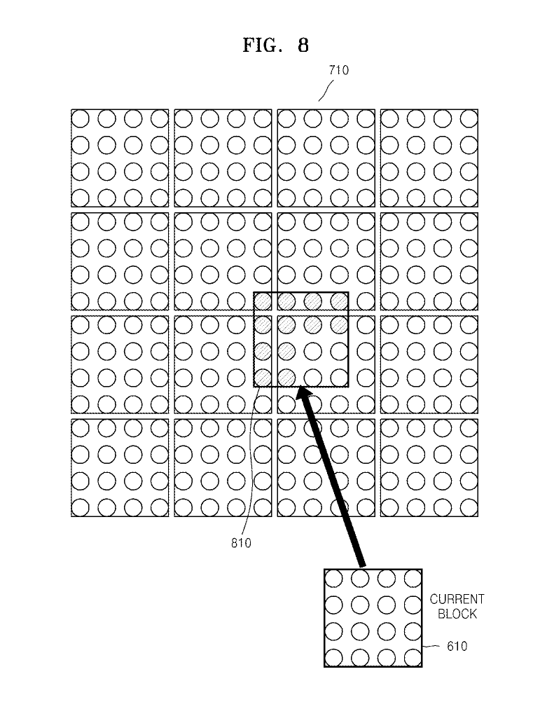

FIG. 8 illustrates an intra prediction method according to another exemplary embodiment of the present invention.

When the current block 610 is a 4×4 block and a prediction value is searched for in the macroblock 710 in the exemplary embodiment described with reference to FIG. 7, the 4×4 current block 610 may have the minimum residue with a block 810, as illustrated in FIG. 8, in the macroblock 710.

Here, the block 810 illustrated in FIG. 8 is laid over four 4×4 blocks in the macroblock 710. Pixels included in the block 810 include block artifacts and the block artifacts decrease the accuracy of prediction.

Accordingly, the filter 414 illustrated in FIG. 4 stores the pre-encoded area of the current block in the frame memory 416 after de-blocking the pre-encoded area of the current block.

Referring back to FIG. 4, the encoder 420 intra prediction encodes the current block which is intra predicted according to the method illustrated in FIGS. 6 and 7.

A prediction value which is intra predicted in the intra predictor 412 is subtracted in the current block in order to generate residue. The generated residue is transformed into a frequency domain in a transformer 422, and then quantized in a quantizer 424. The quantized residue is then encoded and output as a bit stream by a re-arranger 426 and an entropy coder 428.

When the current block is intra predicted using the intra prediction method according to the current exemplary embodiment, the intra prediction performer 410 performs the intra prediction encoding so that information indicating that the current block is predicted using the intra prediction method according to the current exemplary embodiment is included. In other words, the pre-encoded area of the current picture is searched using pre-encoded pixels adjacent to the current block, and the intra prediction encoding is performed so that information about an intra prediction mode showing that the current block is predicted based on the result of the search is included.

When pixels having the minimum residue with pixels adjacent to the current block are searched for and the current block is predicted using a block adjacent to the searched for pixels, only the information indicating that the current block is intra prediction encoded using the intra prediction method of the current exemplary embodiment is transmitted.

However, as illustrated in FIG. 6, when the N pixels 621, 631, 641, and 651 are searched for in order of minimum residue with the pixels adjacent to the current block, the intra prediction encoding is performed while information for specifying a block(s) used in predicting the current block from among N blocks adjacent to the N pixels 621, 631, 641, and 651 is included.

Here, a method of transmitting a coordinate of the block used in predicting the current block in order to specify the block used in the prediction is performed while including information about the vector 332 illustrated in FIG. 3, in the same manner as the related art method described with reference to FIG. 3. Accordingly, the compression rate of intra prediction encoding is not remarkably improved.

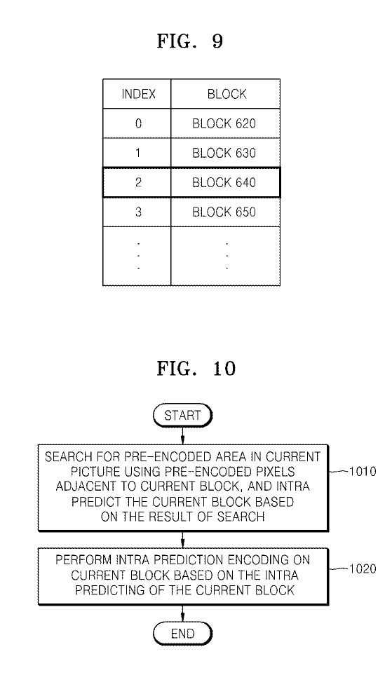

Consequently, the encoder 420 may arrange the searched N blocks in a predetermined order and only transmit an index of a block used in intra prediction in order to increase the compression rate of intra prediction encoding. This will be described in detail with reference to FIG. 9.

FIG. 9 illustrates a method of encoding information about an intra prediction method according to an exemplary embodiment of the present invention.

Referring to FIG. 9, the intra prediction performer 410 predicts the current block from at least one of the N blocks of the pre-encoded area of the current picture as illustrated in FIG. 6.

At this time, the N blocks are arranged in a predetermined order. In FIG. 9, the N blocks are arranged in order of minimum residue by comparing pixels adjacent to the current block and N pixels searched for in the pre-encoded area of the current picture. It is assumed that residue between the pixels adjacent to the current block and the pixels 621 adjacent to the block 620 is the minimum, and residues increase in the order of pixels 631, pixels 641, and pixels 651.

At this time, when the block 640 from among the N blocks is determined to be the best at predicting the current block by comprising the N blocks with the current block, the encoder 420 generates a bit stream by encoding only an index of the block 640, i.e., 2.

While decoding the current block, a receiver, upon receiving the bit stream, selects N pixels in order of the minimum residue by searching a pre-decoded area using the pixels adjacent to the current block, and arranges N blocks adjacent to each pixel in a particular order. Then, the current block is predicted using a block having 2 as an index, and restores the current block based on the block.

Referring back to FIG. 4, the decoder 450 decodes the current block which is encoded in the encoder 420 in order to use the current block while intra prediction encoding a next block. The decoded current block is de-blocked through the filter 414 and stored in the frame memory 416.

The exemplary embodiments of the present invention are described in FIGS. 4 through 9, assuming that the current block is a 4×4 block. However, the size of the current block does not have to be 4×4, and one of ordinary skill in the art can easily understand that the present invention can be applied to blocks having various sizes, such as 8×4, 8×8, 8×16, etc.

In addition, the intra prediction method of the present invention and a related art prediction method using an intra prediction direction can be used simultaneously on one picture while performing intra prediction. In this case, macroblocks included in the picture or sub blocks included in one macroblock can perform intra prediction encoding using either one of the methods.

FIG. 10 illustrates a method of encoding based on intra prediction according to an exemplary embodiment of the present invention.

Referring to FIG. 10, an apparatus for encoding based on an intra prediction according to an exemplary embodiment of the present invention searches for a pre-encoded area in a current picture using pre-encoded pixels adjacent to a current block, and predicts the current block based on the result of the search in operation 1010.

N pixels are selected in order of minimum residue with pixels adjacent to the current block, and the prediction of the current block is performed by selecting N blocks adjacent to the N pixels as blocks used in predicting the current block.

Also, only M macroblocks, having a low compression rate of encoding, may be searched for in the pre-encoded area in the current picture and then the blocks used in predicting the current block may be selected while performing the prediction of the current block.

In addition, accuracy of the prediction may be increased by searching the pre-encoded area using the pixels adjacent to the current block after performing de-blocking of the pre-encoded area.

In operation 1020, the apparatus performs intra prediction encoding on the current block so that information indicating that the current block is intra predicted using the intra prediction method of an exemplary embodiment of the present invention is included.

Information about an intra prediction mode indicating that the current block is intra predicted using the intra prediction method of an exemplary embodiment of the present invention is encoded and inserted into a bit stream.

When N pixels 621, 631, 641, and 651 are searched for in order of minimum residue with the pixels adjacent to the current block as illustrated in FIG. 6, information for specifying a block(s) used in predicting the current block from among N blocks adjacent to the N pixels 621, 631, 641, and 651 is encoded and inserted into the bit stream.

At this time, N blocks may be arranged in a predetermined order and only an index of a block used in predicting the current block may be encoded and inserted into the bit stream.

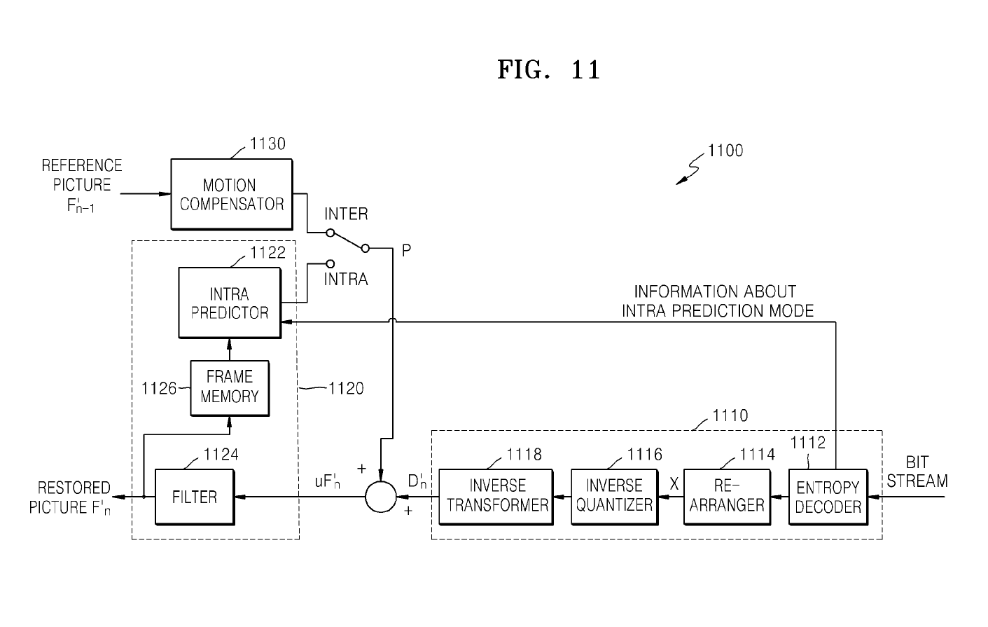

FIG. 11 illustrates an image decoding apparatus 1100 including an apparatus for decoding based on intra prediction according to an exemplary embodiment of the present invention.

Referring to FIG. 11, the image decoding apparatus 1100 includes an extractor 1110, an intra prediction performer 1120, and a motion compensator 1130. Here, the extractor 1110 and the intra prediction performer 1120 correspond to the apparatus for decoding based on intra prediction according to the current exemplary embodiment.

The extractor 1110 receives a bit stream including data about a current block, and extracts the data about the current block and information about an intra prediction mode used in intra predicting the current block.

When the current block is intra predicted using the intra prediction method of an exemplary embodiment of the present invention, a pre-encoded area in a current picture is searched using pre-encoded pixels adjacent to the current block, a bit stream including information indicating that the current block is predicted based on the result of the search, and the data about the current block and the information about the intra prediction mode are extracted from the received bit stream.

The information about the intra prediction mode includes information indicating that the current block is intra prediction encoded using the intra prediction method illustrated in FIGS. 6 through 8.

An entropy decoder 1112 and a re-arranger 1114 receive a compressed bit stream, perform entropy decoding, and generate a quantized coefficient. The generated coefficient is converted to data about residue of the current block via an inverse quantizer 1116 and an inverse transformer 1118.

The intra prediction performer 1120 performs intra prediction, in which a prediction block of the current block is searched for in the current picture, according to information about the intra prediction mode extracted from the extractor 1110. Specifically, the intra prediction performer 1120 may perform the intra prediction in the 16×16 intra prediction mode, the 4×4 intra prediction mode, the 8×8 intra prediction mode, or the chrominance intra prediction mode illustrated in FIGS. 1 and 2 by receiving the current block that is to be prediction encoded as in the related art technology. Also, the intra prediction performer 1120 searches for the pre-encoded area in the current picture using the pre-encoded pixels adjacent to the current block, and predicts the current block based on the result of the search.

An area which is pre-decoded by the extractor 1110 from among areas included in the current picture is stored in a frame memory 1126 in order to be used by the intra predictor 1122. The intra predictor 1122 searches for the pre-encoded area of the current picture stored in the frame memory 1126 using the pixels adjacent to the current block, and predicts the current block based on the result of the search.

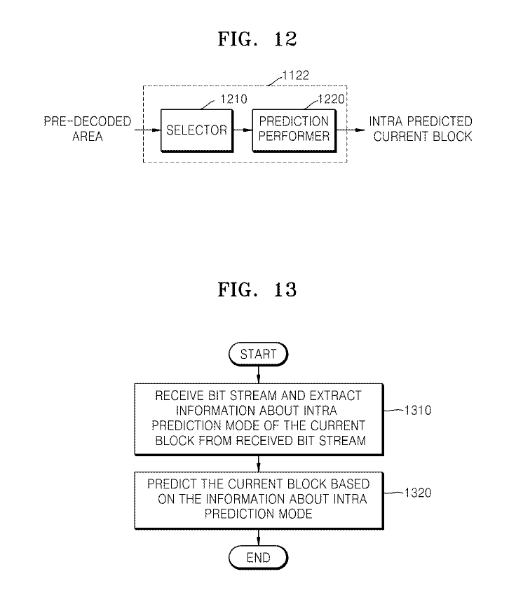

FIG. 12 illustrates an intra predictor 1122 of an apparatus for decoding based on intra prediction according to an exemplary embodiment of the present invention.

Referring to FIG. 12, the intra predictor 1122 according to the current exemplary embodiment includes a selector 1210 and a prediction performer 1220.

The selector 1210 searches a pre-encoded area of a current picture stored in the frame memory of FIG. 4 in order to search for a block that is to be used in predicting a current block.

Preferably, the pre-encoded area of the current picture is searched using pre-encoded pixels adjacent to the current block. While performing the search, N pixels are selected in order of minimum residue with the pixels adjacent to the current block.

Here, only M macroblocks having a low compression rate of encoding from within the pre-encoded area in the current picture may be searched in order to select the block used in predicting the current block.

The prediction performer 1220 predicts the current block based on the block selected by the selector 1210. When the selector 1210 selects N blocks, the current block is predicted based on at least one of the selected N blocks.

Information about an intra prediction mode extracted from the extractor 1110 contains an index of a block from among the N blocks used in intra prediction encoding the current block, and thus the current block is predicted based on the index. The block predicted in the prediction performer 1220 is added with residue and restored to the current block.

FIG. 13 illustrates a method of decoding based on intra prediction according to an exemplary embodiment of the present invention.

Referring to FIG. 13, in operation 1310, an apparatus for decoding based on an intra prediction according to an exemplary embodiment of the present invention receives a bit stream including information indicating that a current block is predicted using the intra prediction method of an exemplary embodiment of the present invention, and extracts information about an intra prediction mode of the current block from the received bit stream.

Data about the current block included in the bit stream is extracted and decoded in order to generate residue. Also, the information about the intra prediction mode included in the bit stream is extracted in order to set an intra prediction method.

In operation 1320, the apparatus predicts the current block based in the information about the intra prediction mode extracted in operation 1310.

A pre-encoded area of a current picture is searched using pixels adjacent to the current block, and the current block is predicted based on the result of the search.

The current block may be predicted by selecting N pixels in order of minimum residue with the pixels adjacent to the current block, and using a block, from among N blocks adjacent to the N pixels, specified by the information about the intra prediction mode.

Also, only M macroblocks having a low compression rate of encoding from within the pre-encoded area in the current picture may be searched for and the current block is predicted based on the result of the search.

In addition, accuracy of the prediction can be increased by performing the search using the pixels adjacent to the current block after performing de-blocking of a pre-decoded area.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

According to the present invention, while intra predicting an image, not only the pre-encoded pixels adjacent to the current block are used, but also blocks included in the pre-encoded area of the current picture are used. Accordingly, intra prediction can be performed accurately and thus a compression rate of intra prediction encoding increases.

In addition, intra prediction decoding and encoding can be performed quickly by searching only for predetermined macroblocks in the pre-encoded area while performing the intra prediction.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding based on intra prediction, the method comprising:
searching for a pre-encoded area in a current picture using pre-encoded pixels adjacent to a current block;
intra predicting the current block based on a result of the searching; and
intra prediction encoding the current block based on the intra predicting the current block.

2. The method of claim 1, wherein the intra prediction encoding the current block comprises performing intra prediction encoding on the current block so that information indicating that the current block is intra predicted by the searching for the pre-encoded area in the current picture using the pre-encoded pixels adjacent to the current block and the intra predicting the current block based on the result of the searching is included.

3. The method of claim 1, wherein the intra predicting the current block comprises:
selecting N blocks adjacent to pixels having low residue with the pre-encoded pixels adjacent to the current block by searching for the pre-encoded area in the current picture using the pre-encoded pixels adjacent to the current block; and
intra predicting the current block based on at least one of the selected N blocks.

4. The method of claim 3, wherein the intra prediction encoding the current block comprises performing the intra prediction encoding so that information for specifying blocks used for the intra predicting the current block from among the N blocks is included.

5. The method of claim 1, wherein the intra predicting the current block comprises intra predicting the current block by searching only for M macroblocks having a low compression rate of encoding from within the pre-encoded area in the current picture.

6. The method of claim 5, wherein the intra predicting the current block comprises:
performing de-blocking on each macroblock included in the pre-encoded area in the current picture;
selecting blocks that are to be used in intra predicting the current block by searching for M macroblocks having a low compression rate of encoding from among the macroblocks; and
intra predicting the current block based on the selected blocks.

7. The method of claim 5, wherein the intra predicting of the current block comprises:
selecting N blocks adjacent to pixels having low residue with the pre-encoded pixels adjacent to the current block by searching for the M macroblocks using the pre-encoded pixels adjacent to the current block; and
intra predicting the current block based on at least one of the selected N blocks.

8. An apparatus for encoding based on an intra prediction, the apparatus comprising:
an intra predictor which searches for a pre-encoded area in a current picture using pre-encoded pixels adjacent to a current block, and intra predicts the current block based on a result of the search; and
an encoder which performs intra prediction encoding on the current block based on the intra prediction of the current block by the intra predictor.

9. The apparatus of claim 8, wherein the encoder performs the intra prediction encoding on the current block so that information indicating that the current block is intra predicted by searching for the pre-encoded area in the current picture using the pre-encoded pixels adjacent to the current block and intra predicting the current block based on the result of the search is included.

10. The apparatus of claim 8, wherein the intra predictor comprises:
a selector which selects N blocks adjacent to pixels having low residue with the pre-encoded pixels adjacent to the current block by searching for the pre-encoded area in the current picture using the pre-encoded pixels adjacent to the current block; and
a prediction performer which intra predicts the current block based on at least one of the N blocks selected by the selector.

11. The apparatus of claim 10, wherein the encoder performs the intra prediction encoding so that information for specifying blocks used in intra predicting the current block from among the N blocks is included.

12. The apparatus of claim 8, wherein the intra predictor intra predicts the current block by searching only for M macroblocks having a low compression rate of encoding from within the pre-encoded area in the current picture.

13. The apparatus of claim 12, wherein the intra predictor comprises:
a filter which performs de-blocking on each macroblock included in the pre-encoded area in the current picture;
a selector which selects blocks that are to be used in intra predicting the current block by searching for M macroblocks having the low compression rate of encoding from among the macroblocks; and
a prediction performer which intra predicts the current block based on the blocks selected by the selector.

14. A method of decoding based on intra prediction, the method comprising:
receiving a bit stream comprising information about an intra prediction mode of the current block indicating that the current block is predicted by searching for a pre-encoded area in a current picture using pre-encoded pixels adjacent to the current block, and extracting the information from the received bit stream; and
intra predicting the current block based on the information about the intra prediction mode.

15. The method of claim 14, wherein the intra predicting the current block comprises:
selecting N blocks adjacent to pixels having low residue with pre-decoded pixels adjacent to the current block using the pre-encoded area in the current picture using the pre-decoded pixels adjacent to the current block; and
intra predicting the current block based on at least one of N blocks according to the information about the intra prediction mode.

16. The method of claim 14, wherein the intra predicting of the current block comprises:
selecting blocks that are to be used in intra predicting the current block by searching only for M macroblocks having a low compression rate of encoding from the pre-encoded area in the current picture; and
intra predicting the current block based on the selected blocks.

17. An apparatus for decoding based on an intra prediction, the apparatus comprising:
an extractor which receives a bit stream including information about an intra prediction mode of a current block indicating that the current block is predicted by searching for a pre-encoded area in a current picture using pre-encoded pixels adjacent to the current block, and extracting the information from the received bit stream; and
an intra predictor which intra predicts the current block based on the information about the intra prediction mode.

18. The apparatus of claim 17, wherein the intra predictor comprises:
a selector which selects N blocks adjacent to pixels having low residue with pre-decoded pixels adjacent to the current block by searching for a pre-decoded area in the current picture using the pre-decoded pixels adjacent to the current block; and
a prediction performer which intra predicts the current block based on at least one of N blocks.

19. The apparatus of claim 17, wherein the intra predictor comprises:
a selector which selects blocks that are to be used in intra predicting the current block by searching only for M macroblocks having a low compression rate of encoding within the pre-decoded area in the current picture; and
a prediction performer which intra predicts the current block based on the selected blocks.

20. A computer readable recording medium having recorded thereon a program for executing the method of claim 1.
